(19) United States
(12) Patent Application Publication
(10) Pub. No.: US 2025/0251959 A1
(43) Pub. Date: Aug. 7, 2025

(54) VIRTUAL MACHINE TEMPLATE BACKUP AND RECOVERY

(71) Applicant: Rubrik, Inc., Palo Alto, CA (US)

(72) Inventors: Jun Ma, Sunnyvale, CA (US); Derrin Rummelt, Grand Rapids, MI (US); Disheng Su, San Jose, CA (US); Yiyao Wu, Mountain View, CA (US)

(21) Appl. No.: 18/431,537

(22) Filed: Feb. 2, 2024

(51) Int. Cl. G06F 9/455

(52) U.S. Cl. CPC G06F 9/45558; G06F 2009/4557

(57) ABSTRACT

Methods, systems, and devices for data management are described. The method may include identifying, by a backup system, a virtual machine template that is usable to instantiate one or more virtual machines on a virtual machine platform in accordance with one or more configuration parameters specified by the virtual machine template, triggering, in accordance with a backup procedure executed by the backup system, instantiation of a virtual machine on the virtual machine platform using the virtual machine template, obtaining, in accordance with the backup procedure and from the virtual machine platform, a snapshot of the instantiated virtual machine, and storing, by the backup system, the snapshot of the instantiated virtual machine, where the snapshot of the instantiated virtual machine supports recovery of the virtual machine template.

### FIELD OF TECHNOLOGY

The present disclosure relates generally to data management, including techniques for virtual machine template backup and recovery.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports virtual machine template backup and recovery in accordance with aspects of the present disclosure.

FIG. 2 shows an example of a computing environment that supports virtual machine template backup and recovery in accordance with aspects of the present disclosure.

FIG. 3 shows an example of a process flow that supports virtual machine template backup and recovery in accordance with aspects of the present disclosure.

FIG. 4 shows a block diagram of an apparatus that supports virtual machine template backup and recovery in accordance with aspects of the present disclosure.

FIG. 5 shows a block diagram of a template manager that supports virtual machine template backup and recovery in accordance with aspects of the present disclosure.

FIG. 6 shows a diagram of a system including a device that supports virtual machine template backup and recovery in accordance with aspects of the present disclosure.

FIGS. 7 through 9 show flowcharts illustrating methods that support virtual machine template backup and recovery in accordance with aspects of the present disclosure.

### DETAILED DESCRIPTION

Virtual machine (VM) platforms may support “templates,” which may be used to create other virtual machines. A virtual machine template is a standardized group of settings, configurations, and files that can be used to repeatedly create new virtual machines. These templates can include the operating system, applications, and service configurations, and the templates are used to ensure consistency and reduce the time it takes to deploy new virtual machines. By using a virtual machine template, administrators can ensure that virtual machines are being deployed with a specific configuration, which can help maintain standards across the infrastructure. In some cases, virtual machine templates may be created based on a deployed virtual machine. Virtual machine templates may be stored in a content library of the virtual machine platform and/or may be a part of a separate hierarchical structure of the virtual machine platform. For example, virtual machine templates may be stored in a content library to support management of library items, such as versioning and distribution (e.g., between multiple virtual machine environments). Virtual machine platforms may not provide backup procedures (e.g., platform-native backup procedures) for virtual machine templates. However, backup services for the virtual machine templates are desirable.

Techniques described herein support backup and recovery of virtual machine templates (within or outside the content library) using a separate backup platform. To support backup of a virtual machine template, the virtual machine template is used to instantiate a virtual machine, a snapshot for the instantiated virtual machine is generated (e.g., natively by the virtual machine platform), and the snapshot of the resulting virtual machine is obtained by the separate backup platform for use as a virtual machine template backup. For recovery of a virtual machine template, the snapshot may be used to recover the corresponding virtual machine as previously instantiated, then the recovered virtual machine may be converted to the corresponding virtual machine template (thereby recovering the virtual machine template). In some cases, two options are available to instantiate a virtual machine template: (1) the virtual machine template is converted into a virtual machine, which results in the template no longer existing, or (2) a new virtual machine is deployed from the template, which results in the template being retained. The conversion process, at least in the case of backup, may be preferred over deployment due to complexities resulting from the template remaining in the virtual machine platform after deployment. However, because the conversion process causes the virtual machine template to cease to exist (at least until a potential re-conversion of the resulting virtual machine back into template form), the conversion process may result in complexities in maintaining the virtual machine hierarchy for templates stored in the content library. Accordingly, the deployment-based backup process may be preferred for virtual machine templates that are stored in the content library. Thus, the conversion-based process may be used to instantiate and backup virtual machine templates that are not in the content library, and the deployment-based process may be used to instantiate and backup templates that are in the content library. Additional techniques described herein support error handling related to template conversion, backup, recovery, and conversion back to templates, as well as template recovery and identifier handling. These and other techniques are described in further detail with respect to the figures.

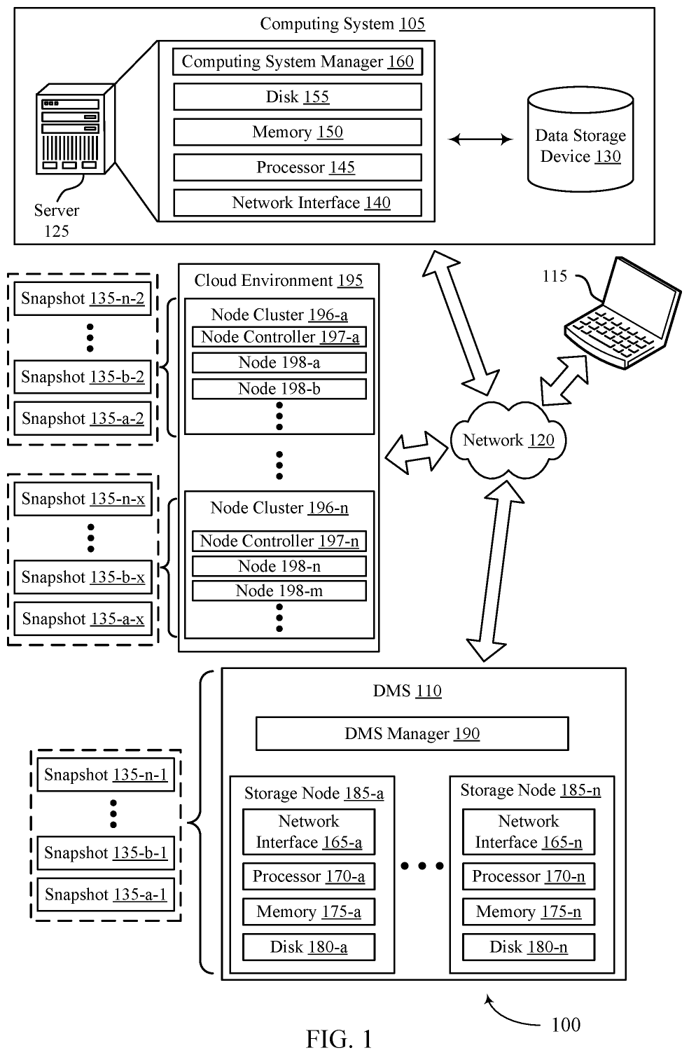

FIG. 1 illustrates an example of a computing environment 100 that supports virtual machine template backup and recovery in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state-which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally or alternatively, the DMS 110 may detect whether aspects of the computing system 105 have been impacted by malware (e.g., ransomware). Additionally or alternatively, the DMS 110 may relocate data or create copies of data based on using one or more snapshots 135 to restore the associated computing object within its original location or at a new location (e.g., a new location within a different computing system 105). Additionally or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

As described herein, the computing system 105 may implement or be implemented by a virtual machine or a virtual machine platform (e.g., host). For example, the computing system 105 may include a virtual machine platform that supports provisioning and management of virtual machines (e.g., on the server 125) to support various applications. The computing system manager 160 may be an example of a virtual machine manager, utility, controller, or the like. In some cases, the computing system manager 160 is an example of vSphere, which is an example of a virtualization platform. As described herein, the computing system manager 160 may be used to generate snapshots of one or more virtual machines instantiated by the computing system 105, and the snapshots may be obtained by backup systems, such as the DMS 110 to support backup and recovery of virtual machine snapshots.

The computing system manager 160 may also support virtual machine templates, which may be used to create other virtual machines. A virtual machine template is a standardized group of settings, configurations, and files that can be used to repeatedly create new virtual machines. These templates can include the operating system, applications, and service configurations, and the templates are used to ensure consistency and reduce the time it takes to deploy new virtual machines. By using a virtual machine template, administrators can ensure that virtual machines are being deployed with a specific configuration, which can help maintain standards across the infrastructure. In some cases, virtual machine templates may be created based on an instantiated virtual machine. Virtual machine templates may be stored in a content library of the virtual machine platform and/or may be a part of a separate hierarchical structure of the virtual machine platform. For example, virtual machine templates may be stored in a content library to support management of library items, such as versioning and distribution (e.g., between multiple virtual machine environments). Virtual machine platforms may not provide backup procedures (e.g., platform-native backup procedures) for virtual machine templates. However, backup and recovery procedures for virtual machine templates may be desirable to ensure that virtual machine templates that are lost, corrupted, or otherwise unobtainable may be regenerated for use in instantiating additional virtual machines based on the virtual machine templates.

Techniques described herein support backup and recovery of virtual machine templates (within or outside the content library) using a separate backup platform. To support backup of a virtual machine template, the virtual machine template is used to instantiate a virtual machine, a snapshot for the instantiated virtual machine is generated (e.g., natively by the virtual machine platform), and the snapshot of the resulting virtual machine is obtained by the separate backup platform (e.g., the DMS 110) for use as a virtual machine template backup. For recovery of a virtual machine template, the snapshot may be used to recover the corresponding virtual machine as previously instantiated, then the recovered virtual machine may be converted to the corresponding virtual machine template (thereby recovering the virtual machine template). In some cases, two options may be available to instantiate a virtual machine template: (1) the virtual machine template is converted into a virtual machine, which results in the template no longer existing in the virtual machine platform, or (2) a new virtual machine is deployed from the template, which results in the template being retained in the virtual machine platform (e.g., the computing system manager 160). The conversion process, at least in the case of backup, may be preferred over deployment due to complexities resulting from the template remaining in the virtual machine platform after deployment. However, because the conversion process causes the virtual machine template to cease to exist (at least until a potential re-conversion of the resulting virtual machine back into template form), the conversion process may result in complexities in maintaining the virtual machine hierarchy for templates stored in the content library. Accordingly, the deployment-based backup process may be preferred for virtual machine templates that are stored in the content library. Thus, the conversion-based process may be used to instantiate and backup virtual machine templates that are not in the content library, and the deployment-based process may be used to instantiate and backup templates that are in the content library.

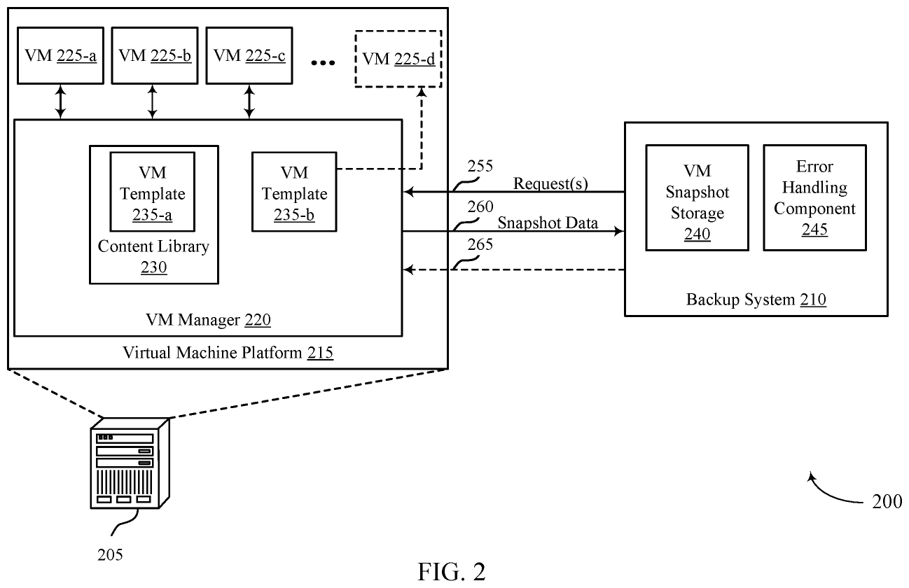

FIG. 2 shows an example of a computing environment 200 that supports virtual machine template backup and recovery in accordance with aspects of the present disclosure. The computing environment 200 includes a server 205 and a backup system 210. The server 205 may be an example of or represent one or more servers that support a computing system 105 as described with respect to FIG. 1. The server 205 may support one or more virtual machine platforms 215 that support instantiation and execution of one or more virtual machines 225. The backup system 210 may be an example of or represent DMS 110 and/or a cloud environment 195 of FIG. 1. The backup system 210 may provide data and snapshot backup services for the virtual machine platform 215. For example, the backup system 210 may store and maintain snapshots of the virtual machines 225 of the virtual machine platform 215, as described with respect to FIG. 1. Accordingly, the backup system 210 may be collocated with the virtual machine platform 215 (e.g., as an on-site backup appliance) or may be a cloud-based or network based backup system, as described herein.

The backup system 210 may communicate with a virtual machine manager 220 of the virtual machine platform 215 to support backup services. More particularly, the virtual machine manager 220 may be an example of the computing system manager 160 described with respect to FIG. 1, and the virtual machine manager 220 may be accessible to generate snapshots of virtual machines, communicate snapshot data, instantiate virtual machines, and other operations. In some examples, the virtual machine manager 220 is a vSphere platform. Thus, the backup system 210 may communicate with the virtual machine manager 220 to perform various techniques described herein. For example, the backup system 210 may transmit one or more API requests to cause generation of snapshots, retrieval of snapshot data, and recovery of virtual machines, among other operations.

The virtual machine manager 220 may, in addition to generating snapshots for virtual machines 225, generate virtual machine templates 235 (e.g., vSphere templates) for virtual machines 225. A virtual machine templates may be an example a master copy of a virtual machine that can be used to create and provision new virtual machines with the same settings and software installations (as the virtual machine from which the template was created), which helps in maintaining consistency across multiple virtual machines. Thus, an administrator use a virtual machine template 235 to instantiate or provision a new virtual machine 225 as more resources are needed. On the other hand, a snapshot may be a point-in-time copy of a virtual machine that captures the state and data of a virtual machine at a specific point in time. Generally, snapshots are used for backup or to save a state before making changes to a virtual machine for reversions back to the state captured by the snapshot if something goes wrong. Therefore, while snapshots could technically be used to create new virtual machines, creation of new virtual machines is not a primary function of snapshots function, and using templates is a more efficient and effective method for this purpose.

Virtual machine templates 235 generated by the virtual machine manager 220 may be stored in various locations within the virtual machine platform 215. For example, virtual machine template 235-a is stored in a location in the virtual machine platform 215 sometimes referred to as a content library (e.g., a content library 230). The content library 230 (and similar management entities) may be an example repository for storage of various templates, such as virtual machine templates, application templates (e.g., vApp templates), and other types of files like ISO images. A content library item of a vSphere template refers to a specific template stored within this content library. Thus, the content library 230 may be an example of a management entity within the virtual machine manager 220 that helps in organizing and distributing these resources (e.g., content library items) across multiple virtual machine platforms or virtual machine managers. Accordingly, the content library 230 can be shared across multiple virtual machine servers, making it a centralized resource.

If a virtual machine template 235 is not stored by the content library (e.g., virtual machine template 235-b), the templates may be stored in datastores, which may be storage locations for virtual machine files, including templates. These datastores may be local or networked, and the datastores may use different types of physical storage technology such as SAN or NAS. When not stored in the content library, these templates may exist as files within these datastores, and the templates be managed and deployed directly from the data stores.

As described, the virtual machine templates 235 may be used to provision/instantiate virtual machines. In some cases, the virtual machine manager 220 may support two different techniques for provisioning a virtual machine based on a template: (1) the virtual machine template 235 is converted into a virtual machine 225, which results in the template no longer existing (e.g., in the content library 230 or the data store), or (2) a new virtual machine is deployed from the template, which results in the template being retained (e.g., in the content library 230 or the data store). In an environment where virtual machines 225 are deployed based on resource needs, the deployment process may be used such that virtual machines may be provisioned dynamically and in a repeated manner. However, in other scenarios, the conversion process may be used.

In some cases, the virtual machine manager 220 or the virtual machine platform 215 may not provide backup services for the virtual machine templates 235. That is, while the backup system 210 may access the virtual machine manager 220 to generate and obtain snapshot data, similar services may not be available for obtaining backup data for virtual machine templates 235. Techniques described herein support backing up of a virtual machine template 235 of the virtual machine platform 215, and the techniques may support backing up virtual machine templates stored in the content library (e.g., virtual machine template 235-a) and outside the content library (e.g., virtual machine template 235-b). Thus, these techniques may support improved data security and efficient virtual machine instantiation and recovery using a virtual machine template backup.

To support such techniques, the backup system 210 may communicate with the virtual machine manager 220 to identify templates and/or storage locations of the templates (e.g., whether the template is stored in the content library 230 or a template datastore). For example, the backup system 210 may transmit one or more requests 255 (e.g., API requests) for information about the templates at the virtual machine platform 215, and the virtual machine manager 220 may provide such information to the backup system 210. The backup system 210 may maintain a listing or log of templates of the virtual machine platform 215. In some cases, the information provided by the virtual machine manager 220 includes an indication of whether a virtual machine template is stored in the content library or not. In such cases, the backup system 210 may tag or otherwise identify those templates that are stored in the content library 230, as such information may be determinative of how a virtual machine template is backed up, as described herein.

After identifying the virtual machine templates 235, the backup system 210 may backup the templates. In some cases, the template backup is triggered in accordance with a schedule (e.g., set forth in a service level agreement), based on input by a user (e.g., a user triggers the backup at a user interface associated with the backup system), or based on some other condition (e.g., a new template is generated or identified by the backup system 210). Backing up a template may involve using a virtual machine template to instantiate a virtual machine, generating a snapshot for the instantiated virtual machine (e.g., natively by the virtual machine platform 215), and obtaining the snapshot (e.g., snapshot data 260) of the virtual machine template 235 by the separate backup system 210 for use as a virtual machine template backup. The backup system 210 may store the obtain snapshot in a virtual machine snapshot storage 240, which may be an example of aspects of the node clusters 196 and/or the storage nodes 185 as described with respect to FIG. 1. For recovery of a virtual machine template, the snapshot may be used to recover the corresponding virtual machine as previously instantiated, then the recovered virtual machine may be converted to the corresponding virtual machine template (thereby recovering the virtual machine template).

To instantiate the virtual machine 225 based on the virtual machine template 235 for a template backup procedure, the backup system 210 may transmit one or more requests 255 (e.g., API requests) to the virtual machine manager 220. As described herein, two procedures (e.g., deployment and conversion) may be available for instantiating the virtual machine based on the virtual machine template by the virtual machine manager 220. The activated procedure may be dependent on whether the virtual machine template is stored in the content library 230 or not.

The conversion process, at least in the case of template backup, may be preferred over deployment due to complexities resulting from the template remaining in the virtual machine platform after deployment. Additionally, the conversion process may not increase the storage and compute resource usage (at least relative to the deployment process). Moreover, the conversion process may allow the converted template to have change block tracking (CBT) provided by the virtual machine platform 215, which makes incremental snapshots attainable on the virtual machine platform 215. The conversion process may be lightweight and less likely to fail during the backup job relative to the deployment process. However, because the conversion process causes the virtual machine template to cease to exist (at least until a potential re-conversion of the resulting virtual machine back into template form), the conversion process may result in complexities in maintaining the virtual machine hierarchy for templates stored in the content library 230 (e.g., virtual machine template 235-a). Accordingly, the deployment-based backup process is preferred for virtual machine templates that are stored in the content library 230. Thus, the conversion-based process may be used to instantiate and backup virtual machine templates that are not in the content library, and the deployment-based process may be used to instantiate and backup templates that are in the content library. Thus, the request 255 transmitted by the backup system 210 to the virtual machine manager 220 may include an instruction for deployment or conversion based on whether the template is stored in the content library 230.

Accordingly, for backing up the virtual machine template 235-a that is stored in the content library 230, the request 255 may indicate that the virtual machine template 235-a be deployed, which may result in the virtual machine 225-d being provisioned or instantiated by the virtual machine manager 220 based on the virtual machine template 235-a. After the virtual machine 225-d is instantiated, the backup system 210 may trigger generation of a snapshot of the virtual machine 225-d by transmitting one or more requests 255 to the virtual machine manager 220. The virtual machine manager 220 may generate the snapshot, and the backup system 210 may obtain the snapshot (e.g., snapshot data 260) from the virtual machine manager 220. The backup system 210 may then store the snapshot as a backup of the virtual machine template 235-a.

For backing up the virtual machine template 235-b that is not stored in the content library 230 (e.g., stored in a template datastore), the request 255 may indicate that the virtual machine template 235-a be converted, which may result in the virtual machine 225-d being provisioned or instantiated by the virtual machine manager 220 based on the virtual machine template 235-b. After the virtual machine 225-d is instantiated, the backup system 210 may trigger generation of a snapshot of the virtual machine 225-d by transmitting one or more requests 255 to the virtual machine manager 220. The virtual machine manager 220 may generate the snapshot, and the backup system 210 may obtain the snapshot (e.g., snapshot data 260) from the virtual machine manager 220. The backup system 210 may then store the snapshot as a backup of the virtual machine template 235-b.

Further, after obtaining the template backup, the backup system 210 may provide recovery services for recovering the corresponding virtual machine template 235 and/or a virtual machine 225 that is based on the virtual machine template 235. For example, in the case of the virtual machine template 235-a being corrupted, lost, or otherwise unusable, the backup system 210 may provide a service for recovering the virtual machine template 235-a. In order to recover the template, the backup system 210 may provide the snapshot data (e.g., the template backup) from the virtual machine snapshot storage 240 to the virtual machine manager 220 in conjunction with an instruction (e.g., via request 265) to instantiate a virtual machine 225 based on the snapshot. The virtual machine manager 220 may instantiate or provision a virtual machine 225 based on the snapshot data received from the backup system 210. After instantiation, the virtual machine manager 220 may convert the virtual machine 225 into a virtual machine template 235, thereby restoring or recovering the virtual machine template 235-a. Similarly, the snapshot data may be used to directly instantiate a virtual machine 225 on the virtual machine platform 215 and/or another virtual machine platform. For example, since the template backup is a snapshot taken from virtual machines, the backup system 210 may support bulk export and live mounting of the snapshot. If a user or customer opts in for automatic conversion, then the export job may cause conversion of the exported virtual machines to templates as described above. If the user or customer opts into automatic cloning to a content library (e.g., content library 230) the export job may attempt to cause cloning of the virtual machine to that content library and remove the exported virtual machine. Thus, these recovery techniques support automatic recovery of templates to the same state as the original virtual machine template.

As the virtual machine 225-d is instantiated in order to generate a backup, it may not be necessary to “power-on” the virtual machine 225-d. That is, the virtual machine 225-d is instantiated without booting or executing one or more applications on the virtual machine 225-d. Booting or executing applications may result in the applications obtaining data or otherwise performing various operations, which may consume unnecessary resources, such as processor, memory, and/or communication resources.

The backup system 210 may perform various techniques to manage the template backups (during and after the backup process). For example, when identifying the templates, the backup system 210 may obtain a template identifier for the virtual machine templates 235 from the virtual machine manager 220. Additionally, the backup system 210 may obtain a separate identifier for the instantiated virtual machine 225-d. The backup system 210 may use the virtual machine identifier for the virtual machine 225-d to perform various operations, such as triggering generation of the snapshot and obtaining the snapshot data for the template backup. Thus, the deployed virtual machine is treated as a snappable, and the deployed virtual machine identifier may substitute the snappable identifier throughout the backup job. That is, the virtual machine identifier substitutes the snappable identifier through the rest of the job whenever the backup system 210 communicates to the virtual machine manager 220. The original snappable identifier may be used when creating a blobstore and other metadata on the backup system 210. The virtual machine snapshot storage 240 may maintain a mapping of various identifiers for snapshots, virtual machine templates, virtual machines, etc.

Additionally, the backup system 210 may provide error handling procedures (e.g., via an error handling component 245) for template backup. For example, if no errors are encountered during the template backup job described herein, then the backup system 210 may cause the converted virtual machine 225 to be converted back to a virtual machine template 235. If errors are encountered, the backup job may make a best effort to convert the virtual machine back to a template. A failed virtual machine to template conversion may not fail the entire job, but may cause the backup system 210 to throw a warning event (e.g., a notification) to notify the administrator to manually perform the conversion by accessing the virtual machine manager 220 directly. In the case of a deployment (e.g., for virtual machine templates in the content library 230), the backup system 210 may make a best effort to destroy or delete the virtual machine 225-d (after obtaining the snapshot). Failure to destroy the deployed virtual machine may not fail the entire job, but may result in the backup system 210 issuing a warning event (e.g., notification) to notify the administrator to manually clean up the deployed virtual machine by accessing the virtual machine manager 220 directly.

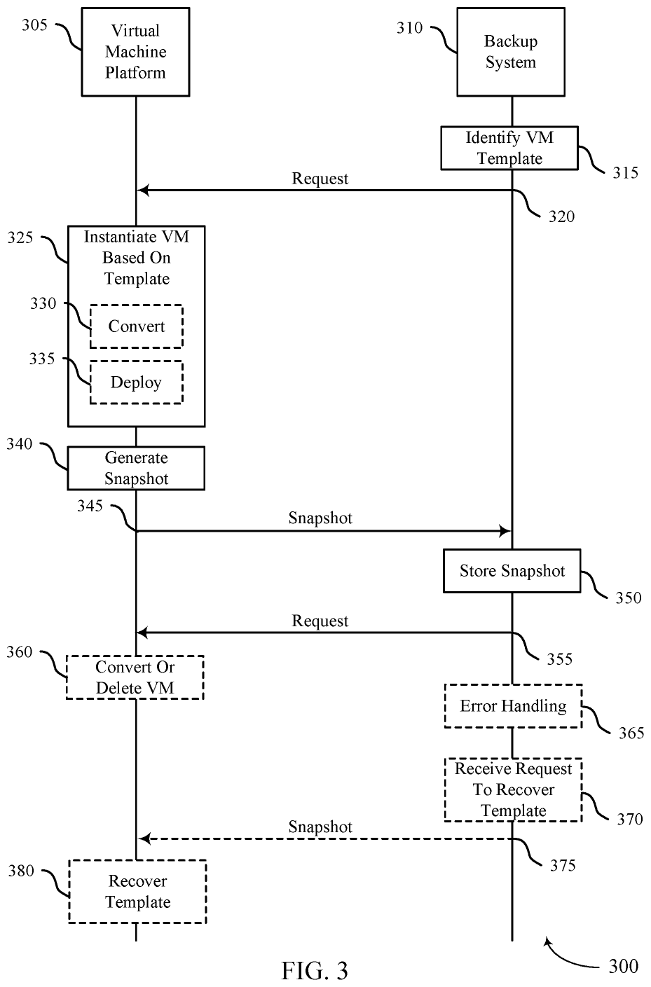

FIG. 3 shows an example of a process flow 300 that supports virtual machine template backup and recovery in accordance with aspects of the present disclosure. The process flow 300 includes a virtual machine platform 305 and a backup system 310. The virtual machine platform 305 may be an example of the virtual machine platform 215 of FIG. 2 or the computing system 105 of FIG. 1. The backup system 310 may be an example of the backup system 210 of FIG. 2 or the DMS 110 of FIG. 1. In the following description of the process flow 300, operations may be added, omitted, or performed in a different order (with respect to the exemplary order shown).

At 315, the backup system 310 may identify a virtual machine template that is usable to instantiate one or more virtual machines on a virtual machine platform in accordance with one or more configuration parameters specified by the virtual machine template. In some cases, the identification may be based on one or more requests (e.g., API requests) sent by the backup system 310 to the virtual machine platform 305 and/or based on one or more communications transmitted by the virtual machine platform 305 to the backup system 310. For example, the backup system 310 may periodically (e.g., on a scheduled basis) request/receive information regarding the virtual machine templates on the virtual machine platform 305.

At 320, the backup system 310 may trigger, in accordance with a backup procedure executed by the backup system 310, instantiation of a virtual machine on the virtual machine platform using the virtual machine template. Triggering instantiation may include transmitting a request (e.g., API request) and the request may include an indication or identifier of the virtual machine template and/or a procedure (e.g., deployment or recovery) for provisioning the virtual machine based on the template. The backup procedure may be a scheduled backup procedure (e.g., based on a service level agreement), a backup procedure requested by a user, a backup procedure initiated by the backup system based on identification of the template, or any combination thereof.

At 325, the virtual machine platform 305 may instantiate the virtual machine based on the template. For example, a virtual machine manager of the virtual machine platform 305 may receive the request and trigger instantiation of the virtual machine template based on the request. In some cases, the virtual machine platform 305 may either convert, at 330, the virtual machine template into the virtual machine or deploy, at 335, the virtual machine from the virtual machine platform. Conversion of the virtual machine template may result in removal of the virtual machine template from the virtual machine platform for conversion. When the virtual machine is deployed based on the virtual machine template, the virtual machine template may remain stored by the virtual machine platform during deployment of the virtual machine (e.g., while the virtual machine is deployed).

Whether the virtual machine is converted from the virtual machine template or deployed based on the template may depend on the request at 320 transmitted by the backup system 310. Thus, at 320, the backup system 310 may transmit, to the virtual machine platform 305, a request to convert the virtual machine template into the virtual machine. In such cases, the backup system 310 may determine that the virtual machine template is maintained in a template hierarchy separate from a content library of the virtual machine platform, and the request to convert the virtual machine template may be transmitted based at least in part on the virtual machine template being maintained in the template hierarchy separate from the content library of the virtual machine platform. In some cases, at 320, the backup system 310 may transmit, to the virtual machine platform, a request to deploy the virtual machine using the virtual machine template. In such cases, the backup system 310 may determine that the virtual machine template is maintained in a content library of the virtual machine platform, and the request to deploy the virtual machine template may be transmitted based at least in part on the virtual machine template being maintained in the content library of the virtual machine platform.

After instantiating the virtual machine based on the template at 325, at 350, the virtual machine platform 305 may generate a snapshot based on the deployed virtual machine. At 340, the virtual machine platform 305 may generate the snapshot based on information included in the request at 320 or based on another request received from the backup system 310. That is, the backup system 310 may monitor the instantiation process (conversion or deployment) and trigger generation of the snapshot based on monitoring the initiation. If the conversion or deployment fails, then the backup system 310 may perform error handling such as by triggering deletion of the virtual machine or conversion back to the template, depending on the process used to instantiate the virtual machine. As described in further detail herein, the backup system 310 may output a notification if instantiation fails.

At 345, the backup system 310 may obtain, in accordance with the backup procedure and from the virtual machine platform, a snapshot of the instantiated virtual machine. Thus, during or after generation of the snapshot, the virtual machine platform may communicate the snapshot data to the backup system 310.

At 350, the backup system 310 may store the snapshot of the instantiated virtual machine. The snapshot of the instantiated virtual machine may support recovery of the virtual machine template.

At 355, the backup system 310 may transmit, to the virtual machine platform 305 after obtaining the snapshot of the virtual machine, a request to convert the virtual machine back into the virtual machine template. The request to convert may be transmitted based on the conversion process being used to instantiate the virtual machine at the virtual machine platform 305. Alternatively, the backup system 310 may transmit, to the virtual machine platform 305, in response to obtaining the snapshot of the virtual machine, a request to delete the deployed virtual machine. The request to delete the deployed virtual machine may be transmitted based on the deployment process being used to instantiate the virtual machine at the virtual machine platform 305.

At 360, the virtual machine platform 305 may, in response to receiving the request at 355 convert the virtual machine back into the virtual machine template or delete the virtual machine.

At 365, the backup system 310 may perform error handling for the conversion or deletion of the virtual machine at the virtual machine platform 305. For example, the backup system 310 may receive, from the virtual machine platform 305, an indication of an error associated with deletion of the virtual machine and output a notification that is indicative of the error and an instruction for resolving the error at the virtual machine platform. Additionally or alternatively, the backup system 310 may receive an indication of an error associated with conversion of the virtual machine back into the virtual machine template and output a notification that is indicative of the error and an instruction for resolving the error at the virtual machine platform.

At 370, the backup system may receive an indication to recover the virtual machine based on the snapshot. For example, the recovery may be based on the virtual machine template being lost, corrupted, or otherwise unusable by the virtual machine platform 305. The request may be received via a user interface associated with the backup system.

At 375, the backup system may trigger, in response to receiving the indication, instantiation of a second virtual machine on the virtual machine platform using the snapshot of the virtual machine. In such cases, the backup system 310 may communicate the snapshot data to the virtual machine platform so that the virtual machine platform 305 can instantiate a virtual machine based on the snapshot data. At 380, the virtual machine platform 305 may recover the virtual machine template based on the instantiated virtual machine, such as by converting the instantiated virtual machine into the virtual machine template.

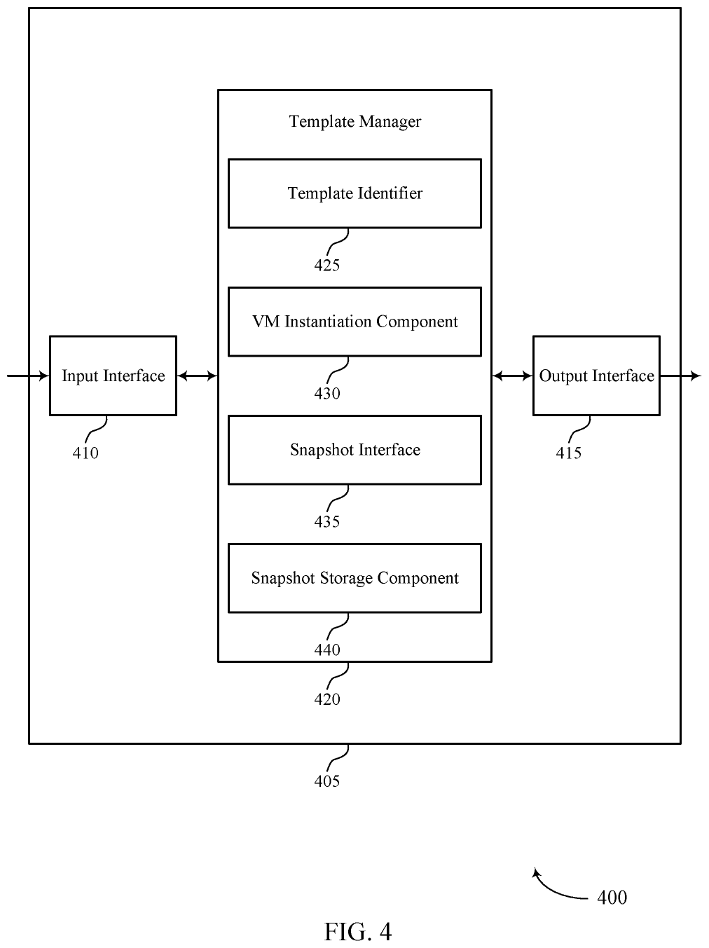

FIG. 4 shows a block diagram 400 of a system 405 that supports virtual machine template backup and recovery in accordance with aspects of the present disclosure. In some examples, the system 405 may be an example of aspects of one or more components described with reference to FIG. 1, such as a DMS 110. The system 405 may include an input interface 410, an output interface 415, and a template manager 420. The system 405 may also include one or more processors. Each of these components may be in communication with one another (e.g., via one or more buses, communications links, communications interfaces, or any combination thereof).

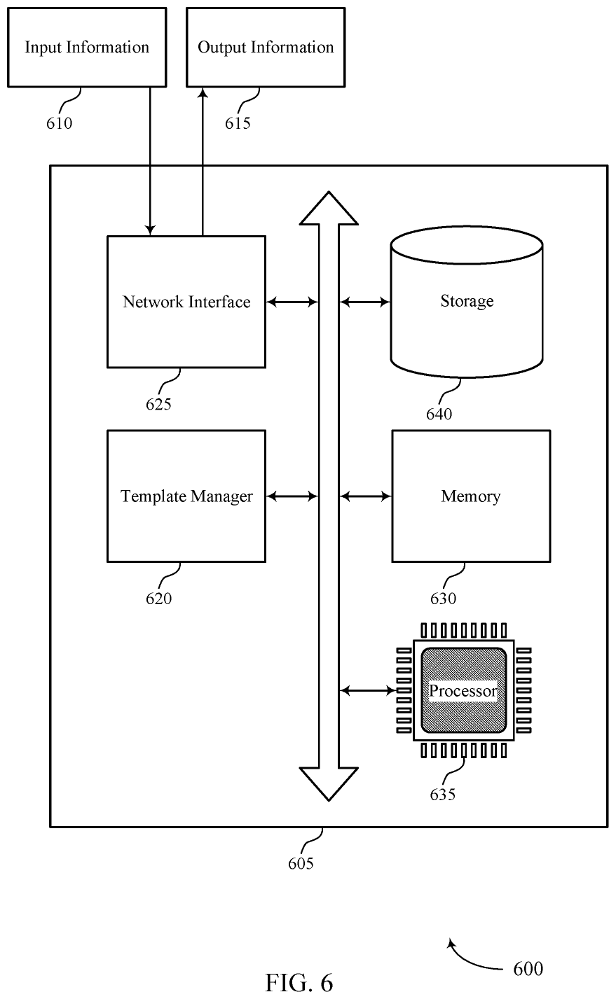

The input interface 410 may manage input signaling for the system 405. For example, the input interface 410 may receive input signaling (e.g., messages, packets, data, instructions, commands, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the template manager 420 to support virtual machine template backup and recovery. In some cases, the input interface 410 may be a component of a network interface 625 as described with reference to FIG. 6.

The output interface 415 may manage output signaling for the system 405. For example, the output interface 415 may receive signaling from other components of the system 405, such as the template manager 420, and may transmit such output signaling corresponding to (e.g., representative of or otherwise based on) such signaling to other systems or devices. In some cases, the output interface 415 may be a component of a network interface 625 as described with reference to FIG. 6.

For example, the template manager 420 may include a template identifier 425, a VM instantiation component 430, a snapshot interface 435, a snapshot storage component 440, or any combination thereof. In some examples, the template manager 420, or various components thereof, may be configured to perform various operations (e.g., receiving, monitoring, transmitting) using or otherwise in cooperation with the input interface 410, the output interface 415, or both. For example, the template manager 420 may receive information from the input interface 410, send information to the output interface 415, or be integrated in combination with the input interface 410, the output interface 415, or both to receive information, transmit information, or perform various other operations as described herein.

The template identifier 425 may be configured as or otherwise support a means for identifying, by a backup system, a virtual machine template that is usable to instantiate one or more virtual machines on a virtual machine platform in accordance with one or more configuration parameters specified by the virtual machine template. The VM instantiation component 430 may be configured as or otherwise support a means for triggering, in accordance with a backup procedure executed by the backup system, instantiation of a virtual machine on the virtual machine platform using the virtual machine template. The snapshot interface 435 may be configured as or otherwise support a means for obtaining, in accordance with the backup procedure and from the virtual machine platform, a snapshot of the instantiated virtual machine. The snapshot storage component 440 may be configured as or otherwise support a means for storing, by the backup system, the snapshot of the instantiated virtual machine, where the snapshot of the instantiated virtual machine supports recovery of the virtual machine template.

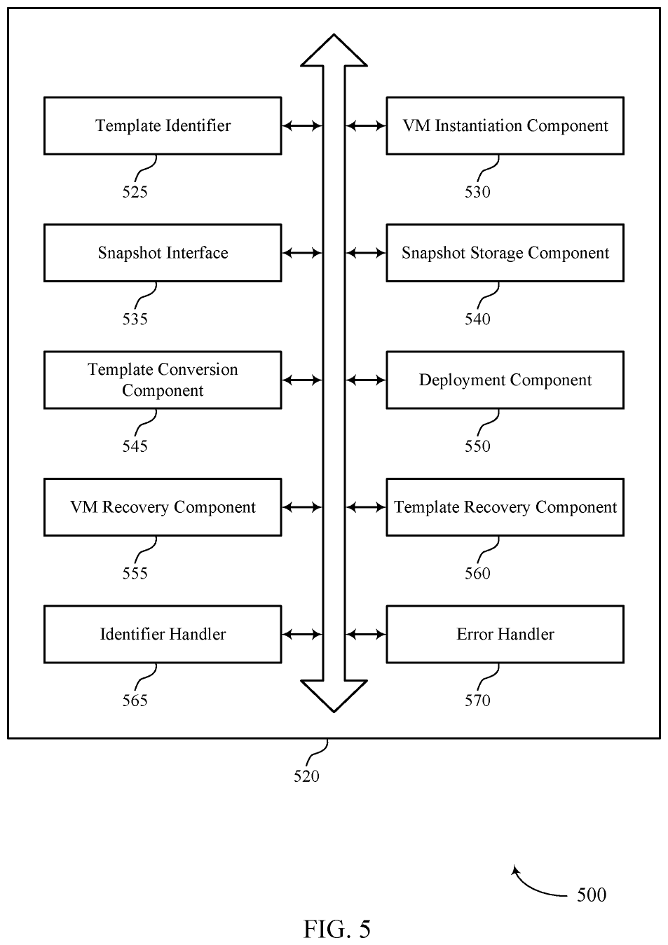

FIG. 5 shows a block diagram 500 of a template manager 520 that supports virtual machine template backup and recovery in accordance with aspects of the present disclosure. The template manager 520 may be an example of aspects of a template manager or a template manager 420, or both, as described herein. The template manager 520, or various components thereof, may be an example of means for performing various aspects of virtual machine template backup and recovery as described herein. For example, the template manager 520 may include a template identifier 525, a VM instantiation component 530, a snapshot interface 535, a snapshot storage component 540, a template conversion component 545, a deployment component 550, a VM recovery component 555, a template recovery component 560, an identifier handler 565, an error handler 570, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The template identifier 525 may be configured as or otherwise support a means for identifying, by a backup system, a virtual machine template that is usable to instantiate one or more virtual machines on a virtual machine platform in accordance with one or more configuration parameters specified by the virtual machine template. The VM instantiation component 530 may be configured as or otherwise support a means for triggering, in accordance with a backup procedure executed by the backup system, instantiation of a virtual machine on the virtual machine platform using the virtual machine template. The snapshot interface 535 may be configured as or otherwise support a means for obtaining, in accordance with the backup procedure and from the virtual machine platform, a snapshot of the instantiated virtual machine. The snapshot storage component 540 may be configured as or otherwise support a means for storing, by the backup system, the snapshot of the instantiated virtual machine, where the snapshot of the instantiated virtual machine supports recovery of the virtual machine template.

In some examples, to support triggering instantiation of the virtual machine, the template conversion component 545 may be configured as or otherwise support a means for transmitting, to the virtual machine platform, a request to convert the virtual machine template into the virtual machine, where conversion of the virtual machine template results in removal of the virtual machine template from the virtual machine platform for conversion.

In some examples, the template identifier 525 may be configured as or otherwise support a means for determining that the virtual machine template is maintained in a template hierarchy separate from a content library of the virtual machine platform, where the request to convert the virtual machine template is transmitted based on the virtual machine template being maintained in the template hierarchy separate from the content library of the virtual machine platform.

In some examples, the template conversion component 545 may be configured as or otherwise support a means for transmitting, to the virtual machine platform after obtaining the snapshot of the virtual machine, a request to convert the virtual machine back into the virtual machine template.

In some examples, the error handler 570 may be configured as or otherwise support a means for receiving an indication of an error associated with conversion of the virtual machine back into the virtual machine template. In some examples, the error handler 570 may be configured as or otherwise support a means for outputting a notification that is indicative of the error and an instruction for resolving the error at the virtual machine platform.

In some examples, to support triggering instantiation of the virtual machine, the deployment component 550 may be configured as or otherwise support a means for transmitting, to the virtual machine platform, a request to deploy the virtual machine using the virtual machine template, where the virtual machine template remains stored by the virtual machine platform during deployment of the virtual machine.

In some examples, the template identifier 525 may be configured as or otherwise support a means for determining that the virtual machine template is maintained in a content library of the virtual machine platform, where the request to deploy the virtual machine template is transmitted based on the virtual machine template being maintained in the content library of the virtual machine platform.

In some examples, the content library supports sharing of content library items in the content library, versioning of the content library items in the content library, or any combination thereof.

In some examples, the deployment component 550 may be configured as or otherwise support a means for transmitting, to the virtual machine platform in response to obtaining the snapshot of the virtual machine, a request to delete the deployed virtual machine.

In some examples, the error handler 570 may be configured as or otherwise support a means for receiving an indication of an error associated with deletion of the virtual machine. In some examples, the error handler 570 may be configured as or otherwise support a means for outputting a notification that is indicative of the error and an instruction for resolving the error at the virtual machine platform.

In some examples, the VM recovery component 555 may be configured as or otherwise support a means for receiving, by the backup system, an indication to recover the virtual machine template on the virtual machine platform. In some examples, the VM instantiation component 530 may be configured as or otherwise support a means for triggering, in response to receiving the indication, instantiation of a second virtual machine on the virtual machine platform using the snapshot of the virtual machine. In some examples, the template conversion component 545 may be configured as or otherwise support a means for triggering conversion of the second virtual machine into a recovered version of the virtual machine template on the virtual machine platform.

In some examples, the template recovery component 560 may be configured as or otherwise support a means for receiving, by the backup system, an indication to recover the virtual machine based on the snapshot. In some examples, the VM instantiation component 530 may be configured as or otherwise support a means for triggering, in response to receiving the indication, instantiation of a second virtual machine on the virtual machine platform using the snapshot of the virtual machine.

In some examples, the identifier handler 565 may be configured as or otherwise support a means for obtaining, from the virtual machine platform, a template identifier for the virtual machine template, where the template identifier is used in the backup system to manage the snapshot. In some examples, the identifier handler 565 may be configured as or otherwise support a means for obtaining, from the virtual machine platform, a virtual machine identifier for the instantiated virtual machine, where the virtual machine identifier is used by the backup system for management of the virtual machine at the virtual machine platform.

In some examples, the virtual machine is instantiated without booting one or more applications on the virtual machine (e.g., without powering on the virtual machine).

FIG. 6 shows a block diagram 600 of a system 605 that supports virtual machine template backup and recovery in accordance with aspects of the present disclosure. The system 605 may be an example of or include components of a system 405 as described herein. The system 605 may include components for data management, including components such as a template manager 620, an input information 610, an output information 615, a network interface 625, at least one memory 630, at least one processor 635, and a storage 640. These components may be in electronic communication or otherwise coupled with each other (e.g., operatively, communicatively, functionally, electronically, electrically; via one or more buses, communications links, communications interfaces, or any combination thereof). Additionally, the components of the system 605 may include corresponding physical components or may be implemented as corresponding virtual components (e.g., components of one or more virtual machines). In some examples, the system 605 may be an example of aspects of one or more components described with reference to FIG. 1, such as a DMS 110.

The network interface 625 may enable the system 605 to exchange information (e.g., input information 610, output information 615, or both) with other systems or devices (not shown). For example, the network interface 625 may enable the system 605 to connect to a network (e.g., a network 120 as described herein). The network interface 625 may include one or more wireless network interfaces, one or more wired network interfaces, or any combination thereof. In some examples, the network interface 625 may be an example of may be an example of aspects of one or more components described with reference to FIG. 1, such as one or more network interfaces 165.

Memory 630 may include RAM, ROM, or both. The memory 630 may store computer-readable, computer-executable software including instructions that, when executed, cause the processor 635 to perform various functions described herein. In some cases, the memory 630 may contain, among other things, a basic input/output system (BIOS), which may control basic hardware or software operation such as the interaction with peripheral components or devices. In some cases, the memory 630 may be an example of aspects of one or more components described with reference to FIG. 1, such as one or more memories 175.

The processor 635 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 635 may be configured to execute computer-readable instructions stored in a memory 630 to perform various functions (e.g., functions or tasks supporting virtual machine template backup and recovery). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. In some cases, the processor 635 may be an example of aspects of one or more components described with reference to FIG. 1, such as one or more processors 170.

Storage 640 may be configured to store data that is generated, processed, stored, or otherwise used by the system 605. In some cases, the storage 640 may include one or more HDDs, one or more SDDs, or both. In some examples, the storage 640 may be an example of a single database, a distributed database, multiple distributed databases, a data store, a data lake, or an emergency backup database. In some examples, the storage 640 may be an example of one or more components described with reference to FIG. 1, such as one or more network disks 180.

For example, the template manager 620 may be configured as or otherwise support a means for identifying, by a backup system, a virtual machine template that is usable to instantiate one or more virtual machines on a virtual machine platform in accordance with one or more configuration parameters specified by the virtual machine template. The template manager 620 may be configured as or otherwise support a means for triggering, in accordance with a backup procedure executed by the backup system, instantiation of a virtual machine on the virtual machine platform using the virtual machine template. The template manager 620 may be configured as or otherwise support a means for obtaining, in accordance with the backup procedure and from the virtual machine platform, a snapshot of the instantiated virtual machine. The template manager 620 may be configured as or otherwise support a means for storing, by the backup system, the snapshot of the instantiated virtual machine, where the snapshot of the instantiated virtual machine supports recovery of the virtual machine template.

By including or configuring the template manager 620 in accordance with examples as described herein, the system 605 may support techniques for virtual machine template backup and recovery, which may provide one or more benefits such as, for example, improved security (e.g., by providing template backup services) as well as improved utilization of computing resources (e.g., by reducing or limiting reconfiguration or reprovisioning of a virtual machine based on a lost or unusable template, among other possibilities.

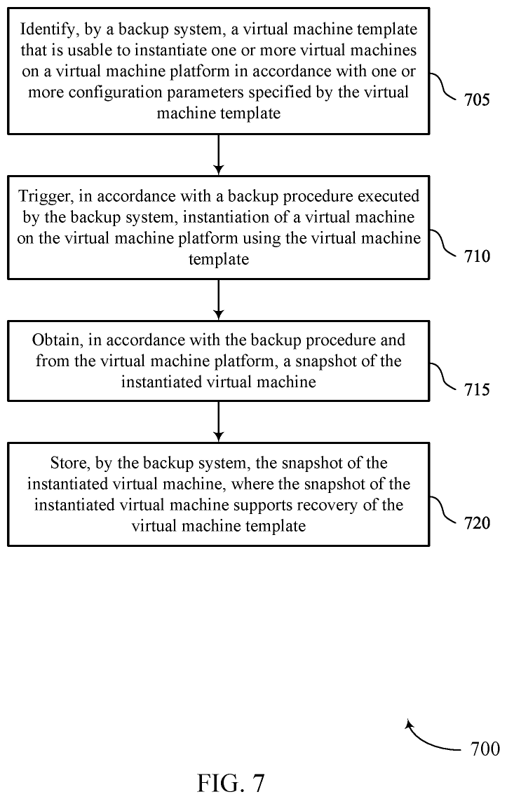

FIG. 7 shows a flowchart illustrating a method 700 that supports virtual machine template backup and recovery in accordance with aspects of the present disclosure. The operations of the method 700 may be implemented by a DMS or its components as described herein. For example, the operations of the method 700 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 705, the method may include identifying, by a backup system, a virtual machine template that is usable to instantiate one or more virtual machines on a virtual machine platform in accordance with one or more configuration parameters specified by the virtual machine template. The operations of 705 may be performed in accordance with examples as disclosed herein. In some examples, aspects of the operations of 705 may be performed by a template identifier 525 as described with reference to FIG. 5.

At 710, the method may include triggering, in accordance with a backup procedure executed by the backup system, instantiation of a virtual machine on the virtual machine platform using the virtual machine template. The operations of 710 may be performed in accordance with examples as disclosed herein. In some examples, aspects of the operations of 710 may be performed by a VM instantiation component 530 as described with reference to FIG. 5.

At 715, the method may include obtaining, in accordance with the backup procedure and from the virtual machine platform, a snapshot of the instantiated virtual machine. The operations of 715 may be performed in accordance with examples as disclosed herein. In some examples, aspects of the operations of 715 may be performed by a snapshot interface 535 as described with reference to FIG. 5.

At 720, the method may include storing, by the backup system, the snapshot of the instantiated virtual machine, where the snapshot of the instantiated virtual machine supports recovery of the virtual machine template. The operations of 720 may be performed in accordance with examples as disclosed herein. In some examples, aspects of the operations of 720 may be performed by a snapshot storage component 540 as described with reference to FIG. 5.

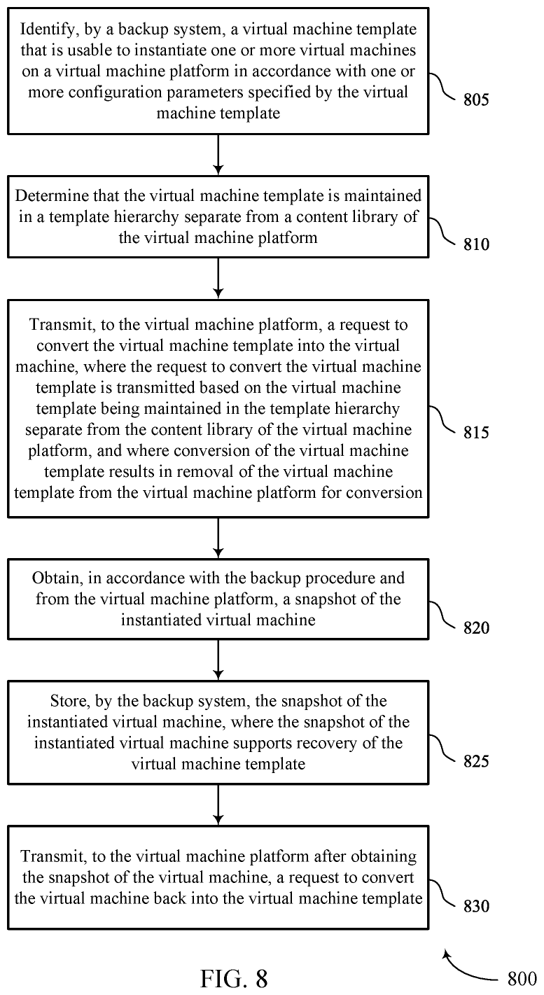

FIG. 8 shows a flowchart illustrating a method 800 that supports virtual machine template backup and recovery in accordance with aspects of the present disclosure. The operations of the method 800 may be implemented by a DMS or its components as described herein. For example, the operations of the method 800 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 805, the method may include identifying, by a backup system, a virtual machine template that is usable to instantiate one or more virtual machines on a virtual machine platform in accordance with one or more configuration parameters specified by the virtual machine template. The operations of 805 may be performed in accordance with examples as disclosed herein. In some examples, aspects of the operations of 805 may be performed by a template identifier 525 as described with reference to FIG. 5.

At 810, the method may include determining that the virtual machine template is maintained in a template hierarchy separate from a content library of the virtual machine platform. The operations of 810 may be performed in accordance with examples as disclosed herein. In some examples, aspects of the operations of 810 may be performed by a template identifier 525 as described with reference to FIG. 5.

At 815, the method may include transmitting, to the virtual machine platform, a request to convert the virtual machine template into the virtual machine, where the request to convert the virtual machine template is transmitted based on the virtual machine template being maintained in the template hierarchy separate from the content library of the virtual machine platform, and where conversion of the virtual machine template results in removal of the virtual machine template from the virtual machine platform for conversion. The operations of 820 may be performed in accordance with examples as disclosed herein. In some examples, aspects of the operations of 820 may be performed by a template conversion component 545 as described with reference to FIG. 5.

At 820, the method may include obtaining, in accordance with the backup procedure and from the virtual machine platform, a snapshot of the instantiated virtual machine. The operations of 825 may be performed in accordance with examples as disclosed herein. In some examples, aspects of the operations of 825 may be performed by a snapshot interface 535 as described with reference to FIG. 5.

At 825, the method may include storing, by the backup system, the snapshot of the instantiated virtual machine, where the snapshot of the instantiated virtual machine supports recovery of the virtual machine template. The operations of 830 may be performed in accordance with examples as disclosed herein. In some examples, aspects of the operations of 830 may be performed by a snapshot storage component 540 as described with reference to FIG. 5.

At 830, the method may include transmitting, to the virtual machine platform after obtaining the snapshot of the virtual machine, a request to convert the virtual machine back into the virtual machine template. The operations of 835 may be performed in accordance with examples as disclosed herein. In some examples, aspects of the operations of 835 may be performed by a template conversion component 545 as described with reference to FIG. 5.

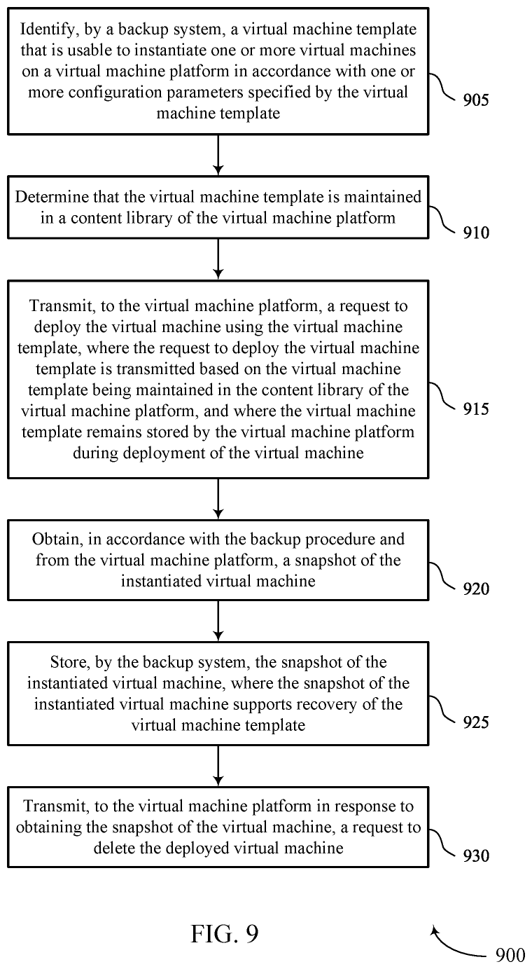

FIG. 9 shows a flowchart illustrating a method 900 that supports virtual machine template backup and recovery in accordance with aspects of the present disclosure. The operations of the method 900 may be implemented by a DMS or its components as described herein. For example, the operations of the method 900 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 905, the method may include identifying, by a backup system, a virtual machine template that is usable to instantiate one or more virtual machines on a virtual machine platform in accordance with one or more configuration parameters specified by the virtual machine template. The operations of 905 may be performed in accordance with examples as disclosed herein. In some examples, aspects of the operations of 905 may be performed by a template identifier 525 as described with reference to FIG. 5.

At 910, the method may include determining that the virtual machine template is maintained in a content library of the virtual machine platform. The operations of 910 may be performed in accordance with examples as disclosed herein. In some examples, aspects of the operations of 910 may be performed by a template identifier 525 as described with reference to FIG. 5.

At 915, the method may include transmitting, to the virtual machine platform, a request to deploy the virtual machine using the virtual machine template, where the request to deploy the virtual machine template is transmitted based on the virtual machine template being maintained in the content library of the virtual machine platform, and where the virtual machine template remains stored by the virtual machine platform during deployment of the virtual machine. The operations of 920 may be performed in accordance with examples as disclosed herein. In some examples, aspects of the operations of 920 may be performed by a deployment component 550 as described with reference to FIG. 5.

At 920, the method may include obtaining, in accordance with the backup procedure and from the virtual machine platform, a snapshot of the instantiated virtual machine. The operations of 925 may be performed in accordance with examples as disclosed herein. In some examples, aspects of the operations of 925 may be performed by a snapshot interface 535 as described with reference to FIG. 5.

At 925, the method may include storing, by the backup system, the snapshot of the instantiated virtual machine, where the snapshot of the instantiated virtual machine supports recovery of the virtual machine template. The operations of 930 may be performed in accordance with examples as disclosed herein. In some examples, aspects of the operations of 930 may be performed by a snapshot storage component 540 as described with reference to FIG. 5.

At 930, the method may include transmitting, to the virtual machine platform in response to obtaining the snapshot of the virtual machine, a request to delete the deployed virtual machine. The operations of 935 may be performed in accordance with examples as disclosed herein. In some examples, aspects of the operations of 935 may be performed by a deployment component 550 as described with reference to FIG. 5.

A method by an apparatus is described. The method may include identifying, by a backup system, a virtual machine template that is usable to instantiate one or more virtual machines on a virtual machine platform in accordance with one or more configuration parameters specified by the virtual machine template, triggering, in accordance with a backup procedure executed by the backup system, instantiation of a virtual machine on the virtual machine platform using the virtual machine template, obtaining, in accordance with the backup procedure and from the virtual machine platform, a snapshot of the instantiated virtual machine, and storing, by the backup system, the snapshot of the instantiated virtual machine, where the snapshot of the instantiated virtual machine supports recovery of the virtual machine template.

An apparatus is described. The apparatus may include one or more memories storing processor executable code, and one or more processors coupled with the one or more memories. The one or more processors may individually or collectively be operable to execute the code to cause the apparatus to identify, by a backup system, a virtual machine template that is usable to instantiate one or more virtual machines on a virtual machine platform in accordance with one or more configuration parameters specified by the virtual machine template, trigger, in accordance with a backup procedure executed by the backup system, instantiation of a virtual machine on the virtual machine platform using the virtual machine template, obtain, in accordance with the backup procedure and from the virtual machine platform, a snapshot of the instantiated virtual machine, and store, by the backup system, the snapshot of the instantiated virtual machine, where the snapshot of the instantiated virtual machine supports recovery of the virtual machine template.

Another apparatus is described. The apparatus may include means for identifying, by a backup system, a virtual machine template that is usable to instantiate one or more virtual machines on a virtual machine platform in accordance with one or more configuration parameters specified by the virtual machine template, means for triggering, in accordance with a backup procedure executed by the backup system, instantiation of a virtual machine on the virtual machine platform using the virtual machine template, means for obtaining, in accordance with the backup procedure and from the virtual machine platform, a snapshot of the instantiated virtual machine, and means for storing, by the backup system, the snapshot of the instantiated virtual machine, where the snapshot of the instantiated virtual machine supports recovery of the virtual machine template.

A non-transitory computer-readable medium storing code is described. The code may include instructions executable by one or more processors to identify, by a backup system, a virtual machine template that is usable to instantiate one or more virtual machines on a virtual machine platform in accordance with one or more configuration parameters specified by the virtual machine template, trigger, in accordance with a backup procedure executed by the backup system, instantiation of a virtual machine on the virtual machine platform using the virtual machine template, obtain, in accordance with the backup procedure and from the virtual machine platform, a snapshot of the instantiated virtual machine, and store, by the backup system, the snapshot of the instantiated virtual machine, where the snapshot of the instantiated virtual machine supports recovery of the virtual machine template.

In some examples of the method, apparatus, and non-transitory computer-readable medium described herein, operations, features, means, or instructions for triggering instantiation of the virtual machine may include operations, features, means, or instructions for transmitting, to the virtual machine platform, a request to convert the virtual machine template into the virtual machine, where conversion of the virtual machine template results in removal of the virtual machine template from the virtual machine platform for conversion.

Some examples of the method, apparatus, and non-transitory computer-readable medium described herein may further include operations, features, means, or instructions for determining that the virtual machine template may be maintained in a template hierarchy separate from a content library of the virtual machine platform, where the request to convert the virtual machine template may be transmitted based on the virtual machine template being maintained in the template hierarchy separate from the content library of the virtual machine platform.

Some examples of the method, apparatus, and non-transitory computer-readable medium described herein may further include operations, features, means, or instructions for transmitting, to the virtual machine platform after obtaining the snapshot of the virtual machine, a request to convert the virtual machine back into the virtual machine template.

Some examples of the method, apparatus, and non-transitory computer-readable medium described herein may further include operations, features, means, or instructions for receiving an indication of an error associated with conversion of the virtual machine back into the virtual machine template and outputting a notification that may be indicative of the error and an instruction for resolving the error at the virtual machine platform.

In some examples of the method, apparatus, and non-transitory computer-readable medium described herein, operations, features, means, or instructions for triggering instantiation of the virtual machine may include operations, features, means, or instructions for transmitting, to the virtual machine platform, a request to deploy the virtual machine using the virtual machine template, where the virtual machine template remains stored by the virtual machine platform during deployment of the virtual machine.

Some examples of the method, apparatus, and non-transitory computer-readable medium described herein may further include operations, features, means, or instructions for determining that the virtual machine template may be maintained in a content library of the virtual machine platform, where the request to deploy the virtual machine template may be transmitted based on the virtual machine template being maintained in the content library of the virtual machine platform.

In some examples of the method, apparatus, and non-transitory computer-readable medium described herein, the content library supports sharing of content library items in the content library, versioning of the content library items in the content library, or any combination thereof.

Some examples of the method, apparatus, and non-transitory computer-readable medium described herein may further include operations, features, means, or instructions for transmitting, to the virtual machine platform in response to obtaining the snapshot of the virtual machine, a request to delete the deployed virtual machine.

Some examples of the method, apparatus, and non-transitory computer-readable medium described herein may further include operations, features, means, or instructions for receiving an indication of an error associated with deletion of the virtual machine and outputting a notification that may be indicative of the error and an instruction for resolving the error at the virtual machine platform.

Some examples of the method, apparatus, and non-transitory computer-readable medium described herein may further include operations, features, means, or instructions for receiving, by the backup system, an indication to recover the virtual machine template on the virtual machine platform, triggering, in response to receiving the indication, instantiation of a second virtual machine on the virtual machine platform using the snapshot of the virtual machine, and triggering conversion of the second virtual machine into a recovered version of the virtual machine template on the virtual machine platform.

Some examples of the method, apparatus, and non-transitory computer-readable medium described herein may further include operations, features, means, or instructions for receiving, by the backup system, an indication to recover the virtual machine based on the snapshot and triggering, in response to receiving the indication, instantiation of a second virtual machine on the virtual machine platform using the snapshot of the virtual machine.

Some examples of the method, apparatus, and non-transitory computer-readable medium described herein may further include operations, features, means, or instructions for obtaining, from the virtual machine platform, a template identifier for the virtual machine template, where the template identifier may be used in the backup system to manage the snapshot and obtaining, from the virtual machine platform, a virtual machine identifier for the instantiated virtual machine, where the virtual machine identifier may be used by the backup system for management of the virtual machine at the virtual machine platform.

In some examples of the method, apparatus, and non-transitory computer-readable medium described herein, the virtual machine may be instantiated without booting one or more applications on the virtual machine.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
identifying, by a backup system, a virtual machine template that is usable to instantiate one or more virtual machines on a virtual machine platform in accordance with one or more configuration parameters specified by the virtual machine template;
triggering, in accordance with a backup procedure executed by the backup system, instantiation of a virtual machine on the virtual machine platform using the virtual machine template;
obtaining, in accordance with the backup procedure and from the virtual machine platform, a snapshot of the instantiated virtual machine; and
storing, by the backup system, the snapshot of the instantiated virtual machine, wherein the snapshot of the instantiated virtual machine supports recovery of the virtual machine template.

2. The method of claim 1, wherein triggering instantiation of the virtual machine comprises:
transmitting, to the virtual machine platform, a request to convert the virtual machine template into the virtual machine, wherein conversion of the virtual machine template results in removal of the virtual machine template from the virtual machine platform for conversion.

3. The method of claim 2, further comprising:
determining that the virtual machine template is maintained in a template hierarchy separate from a content library of the virtual machine platform, wherein the request to convert the virtual machine template is transmitted based at least in part on the virtual machine template being maintained in the template hierarchy separate from the content library of the virtual machine platform.

4. The method of claim 2, further comprising:
transmitting, to the virtual machine platform after obtaining the snapshot of the virtual machine, a request to convert the virtual machine back into the virtual machine template.

5. The method of claim 4, further comprising:
receiving an indication of an error associated with conversion of the virtual machine back into the virtual machine template; and
outputting a notification that is indicative of the error and an instruction for resolving the error at the virtual machine platform.

6. The method of claim 1, wherein triggering instantiation of the virtual machine comprises:
transmitting, to the virtual machine platform, a request to deploy the virtual machine using the virtual machine template, wherein the virtual machine template remains stored by the virtual machine platform while the virtual machine is deployed.

7. The method of claim 6, further comprising:
determining that the virtual machine template is maintained in a content library of the virtual machine platform, wherein the request to deploy the virtual machine template is transmitted based at least in part on the virtual machine template being maintained in the content library of the virtual machine platform.

8. The method of claim 7, wherein the content library supports sharing of content library items in the content library, versioning of the content library items in the content library, or any combination thereof.

9. The method of claim 6, further comprising:
transmitting, to the virtual machine platform in response to obtaining the snapshot of the virtual machine, a request to delete the deployed virtual machine.

10. The method of claim 9, further comprising:
receiving an indication of an error associated with deletion of the virtual machine; and
outputting a notification that is indicative of the error and an instruction for resolving the error at the virtual machine platform.

11. The method of claim 1, further comprising:
receiving, by the backup system, an indication to recover the virtual machine template on the virtual machine platform;
triggering, in response to receiving the indication, instantiation of a second virtual machine on the virtual machine platform using the snapshot of the virtual machine; and
triggering conversion of the second virtual machine into a recovered version of the virtual machine template on the virtual machine platform.

12. The method of claim 1, further comprising:
receiving, by the backup system, an indication to recover the virtual machine based on the snapshot; and
triggering, in response to receiving the indication, instantiation of a second virtual machine on the virtual machine platform using the snapshot of the virtual machine.

13. The method of claim 1, further comprising:
obtaining, from the virtual machine platform, a template identifier for the virtual machine template, wherein the template identifier is used in the backup system to manage the snapshot; and
obtaining, from the virtual machine platform, a virtual machine identifier for the instantiated virtual machine, wherein the virtual machine identifier is used by the backup system for management of the virtual machine at the virtual machine platform.

14. The method of claim 1, wherein the virtual machine is instantiated without booting one or more applications on the virtual machine.

15. An apparatus, comprising:
one or more memories storing processor-executable code; and
one or more processors coupled with the one or more memories and individually or collectively operable to execute the code to cause the apparatus to:
identify, by a backup system, a virtual machine template that is usable to instantiate one or more virtual machines on a virtual machine platform in accordance with one or more configuration parameters specified by the virtual machine template;
trigger, in accordance with a backup procedure executed by the backup system, instantiation of a virtual machine on the virtual machine platform using the virtual machine template;
obtain, in accordance with the backup procedure and from the virtual machine platform, a snapshot of the instantiated virtual machine; and
store, by the backup system, the snapshot of the instantiated virtual machine, wherein the snapshot of the instantiated virtual machine supports recovery of the virtual machine template.

16. The apparatus of claim 15, wherein, to trigger instantiation of the virtual machine, the one or more processors are individually or collectively operable to execute the code to cause the apparatus to:
transmit, to the virtual machine platform, a request to convert the virtual machine template into the virtual machine, wherein conversion of the virtual machine template is configured to result in removal of the virtual machine template from the virtual machine platform for conversion.

17. The apparatus of claim 15, wherein, to trigger instantiation of the virtual machine, the one or more processors are individually or collectively operable to execute the code to cause the apparatus to:
transmit, to the virtual machine platform, a request to deploy the virtual machine using the virtual machine template, wherein deployment of the virtual machine template is configured to cause the virtual machine template to remain stored by the virtual machine platform while the virtual machine is deployed.

18. A non-transitory computer-readable medium storing code, the code comprising instructions executable by one or more processors to:
identify, by a backup system, a virtual machine template that is usable to instantiate one or more virtual machines on a virtual machine platform in accordance with one or more configuration parameters specified by the virtual machine template;
trigger, in accordance with a backup procedure executed by the backup system, instantiation of a virtual machine on the virtual machine platform using the virtual machine template;
obtain, in accordance with the backup procedure and from the virtual machine platform, a snapshot of the instantiated virtual machine; and
store, by the backup system, the snapshot of the instantiated virtual machine, wherein the snapshot of the instantiated virtual machine supports recovery of the virtual machine template.

19. The non-transitory computer-readable medium of claim 18, wherein, to trigger instantiation of the virtual machine, the instructions are executable by the one or more processors to:
transmit, to the virtual machine platform, a request to convert the virtual machine template into the virtual machine, wherein conversion of the virtual machine template is configured to result in removal of the virtual machine template from the virtual machine platform for conversion.

20. The non-transitory computer-readable medium of claim 18, wherein the instructions to trigger instantiation of the virtual machine are executable by the one or more processors to:
transmit, to the virtual machine platform, a request to deploy the virtual machine using the virtual machine template, wherein deployment of the virtual machine template is configured to cause the virtual machine template to remain stored by the virtual machine platform while the virtual machine is deployed.
